(19) United States
(12) Patent Application Publication
(10) Pub. No.: US 2025/0110029 A1
(43) Pub. Date: Apr. 3, 2025

(54) METHODS AND APPARATUS FOR EVAPORATING A LIQUID COMPONENT FROM A LIQUID SAMPLE IN A CONTAINER

(71) Applicant: Genevac Limited, Ipswich (GB)

(72) Inventors: Richard William YOUNG, Ipswich (GB); Philip Rufino CUDDEHAY, Ipswich (GB); Induka Ruwanthi ABEYSENA, Ipswich (GB); Donald Roger LEE-SMITH, Hadleigh (GB); Gavin Richard PAGE, Wolverstone (GB)

(21) Appl. No.: 18/833,135

(22) PCT Filed: Mar. 6, 2023
(86) PCT No.: PCT/GB2023/050519

§ 371 Date: Jul. 25, 2024

(30) Foreign Application Priority Data
Mar. 8, 2022 (GB) 2203169.4

(51) Int. Cl. G01N 1/40; B01L 3/00; B01L 7/00; G05D 23/19; H05B 1/02

(52) U.S. Cl. CPC G01N 1/4022; B01L 3/508; B01L 7/00; G05D 23/1904; H05B 1/0244; B01L 2300/0663; B01L 2300/1844; G01N 2001/4027

(57) ABSTRACT

A method and apparatus for conducting an evaporation procedure to evaporate a liquid component from a liquid sample in a container. The method comprises heating the container towards a target temperature using a heat source having a thermostatic control arrangement, iteratively determining a value of a heat flow parameter with a controller, determining with the controller when the heat flow parameter value has fallen by a predetermined extent from a peak value, and outputting a control signal from the controller in response to said determination, the control signal causing a further step in the evaporation procedure to be carried out.

### FIELD OF THE DISCLOSURE

The present disclosure relates to methods and apparatus for evaporating a liquid component from a liquid sample in a container, and more particularly to determining the endpoint of an evaporation process.

### BACKGROUND TO THE DISCLOSURE

Sample evaporators are used to evaporate a liquid component from a sample until the sample is dry. It is desirable to be able to automatically determine when an evaporation process has been completed so that a human operator is not required to continually monitor the process. Furthermore, it is preferable for the evaporation process to be completed as soon as possible to minimise the time taken. Also, some samples may be heat sensitive and so it may also be advantageous to minimise the heating time to avoid damaging the sample.

In some existing evaporators, an endpoint for an evaporation process is determined with reference to the temperature of the sample container.

### SUMMARY OF THE DISCLOSURE

The present disclosure provides a method of conducting an evaporation procedure using an evaporator to evaporate a liquid component from a liquid sample in a container, the method comprising the steps of:
heating the container towards a target temperature using a heat source having a thermostatic control arrangement;
iteratively determining a value of a heat flow parameter with a controller, wherein the heat flow parameter is related to the amount of heat energy outputted by the heat source during an immediately preceding time period,
detecting a peak in the value of the heat flow parameter with the controller;
determining with the controller when the heat flow parameter value has fallen by a predetermined extent from its peak value; and
outputting a control signal from the controller in response to said determination, the control signal causing a further step in the evaporation procedure to be carried out.

The controller may be a controller of the evaporator. The further step may be a process step conducted by a component of the evaporator or by a device coupled to the evaporator in response to the control signal outputted by the controller. For example, the further step may be to stop the process of heating of the container with the heat source to maintain the target temperature; to trigger a next stage in an evaporation procedure which may have different parameter settings, such as different pressure and/or temperature levels; to conduct a drain process to remove a condensed solvent from a condenser coupled to the evaporator; and/or to carry out a defrost procedure to clear a condensing element of a condenser coupled to the evaporator.

By determining the endpoint of the evaporation process with reference to a heat flow parameter, it is possible to more reliably determine when evaporation has completed. In particular, determination of the endpoint with reference to a detected peak value of the heat flow parameter has been found to provide more reliable control.

The heating of the container by the heat source may for example be stopped when the heat flow parameter value falls to a predetermined proportion or percentage of its peak value.

In some preferred implementations the method includes a step of monitoring a temperature indicative of that of the sample container, wherein the preceding time period only starts when or after the monitored temperature has been raised by the heat source to a threshold temperature during the current evaporation procedure. This may be beneficial for many processes as the amount of heat energy required to raise the temperature of the sample container and an associated holder towards the target temperature may be substantially greater than the energy required for evaporation. By only starting the time period used to determine the heat flow parameter once a threshold temperature has been reached, the monitoring of the heat flow parameter can be more sensitive to the amount of heat energy used in evaporation of solvent as a peak in the value of the heat flow parameter may then be detected and used as an indication of the time at which a peak evaporation rate is achieved.

The threshold temperature may be equal to or a predetermined extent (around 3 to 5° C. for example) below the target temperature.

The heat flow parameter may be dependent on the proportion of the preceding time period for which the heat source was on.

The heat flow parameter may be dependent on the proportion of a set of time points during the preceding time period when the heat source was on. For example, the time points may be spaced over the time period at equal intervals.

The preceding time period may have a predetermined length or may correspond to the time that has elapsed since the start of the evaporation procedure if this is shorter than the predetermined length of time.

The controller may determine when the heat flow parameter value has fallen to a predetermined percentage of its peak value.

The determination of the endpoint of the evaporation process may also be made with reference to a signal related to the pressure within the evaporator enclosure and/or a signal related to the sample temperature.

The present disclosure further provides an evaporator arranged to carry out an evaporation procedure to evaporate a liquid component from a liquid sample in a container as described herein, the evaporator comprising:
a heat source for heating the container and having a thermostatic control arrangement; and
a controller which is communicatively coupled to the heat source and is configured to determine the heat flow parameter, detect a peak in the value of the heat flow parameter, determine when the heat flow parameter value has fallen by a predetermined extent from its peak value, and output a control signal in response to said determination, the control signal causing a further step in the evaporation procedure to be carried out.

The evaporation methods described herein may be deployed in various types of evaporator. For example, it may be utilised in centrifugal evaporators, rotary evaporators and static evaporators.

### BRIEF DESCRIPTION OF THE DRAWINGS

Examples of the present disclosure will now be described with reference to the accompanying schematic drawings, wherein:

FIG. 1 is a cross-sectional side view of a centrifugal evaporator according to an example of the present disclosure; and

FIGS. 2 to 4 are graphical illustrations of evaporation processes and their control using techniques according to the present disclosure alongside techniques outside the scope of the present disclosure.

### DETAILED DESCRIPTION

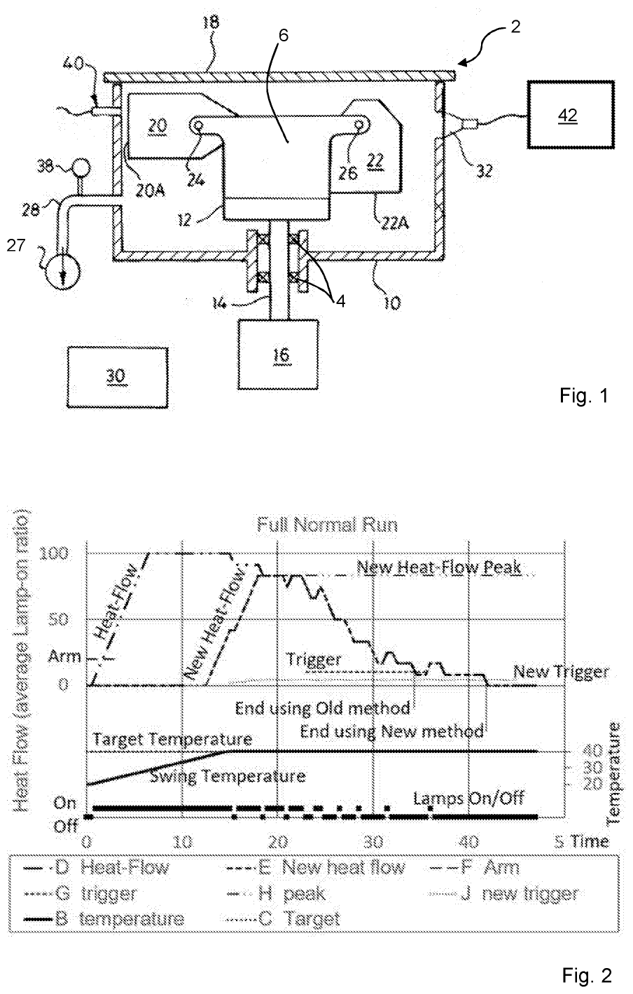

FIG. 1 shows a centrifugal evaporator 2 having an evaporation chamber 10. The chamber contains a rotor assembly 12 carried by a central shaft 14 which is rotatably coupled to the chamber via bearings 4. An electric drive 16 is coupled to the shaft for rotating the shaft relative to the chamber.

Two sample holders 20 and 22 are pivotally mounted on the rotor 6 of the rotor assembly 12 by respective pivots 24 and 26. When the rotor is stationary, each holder is upright as illustrated by holder 22 in FIG. 1. When the rotor is rotated at speed, the holders swing outwards into the pivoted orientation of holder 20 in FIG. 1. Sample containers may be inserted into the sample holders via an opening at the top of the evaporator, which is closed by a lid 18 prior to starting an evaporation process.

A vacuum pump 27 is connected to the chamber by a pipe 28. The pressure within the pipe is monitored by a pressure sensor 38.

A heat source 32 is arranged to heat the interior of the evaporation chamber. It May for example be an infrared radiation source. Alternatively, a resistive heater may be used to heat the chamber. A temperature sensor 40 is provided to sense the temperature of the sample holders 20 and 22. A thermostatic control arrangement 42 is coupled to the source 32 and operable to turn the heat source on and off with reference to a temperature signal generated by the temperature sensor 40. The thermostatic control arrangement is arranged to keep the heat source on until a target temperature is reached, and then turn the heat source off and on as appropriate to keep the measured temperature at or close to the target temperature.

The evaporator is controlled by a controller 30, which is communicatively coupled to the electric drive 16, vacuum pump 27, temperature sensor 40 and the thermostatic control arrangement 42. The controller may be embodied in practice by a number of separate control devices.

During an evaporation procedure, the rotor is rotated at high speed causing the holders 20 and 22 to swing radially outwards. The undersides 20A and 22A of the holders are then presented in turn to face the heat source 32, thereby warming the holders and their contents.

The controller is configured to determine when to end an evaporation process having regard to input signals which are responsive to the operation of the heat source. The signals are used by the controller to determine a heat flow parameter which is indicative of the proportion of an immediately preceding period of time for which the heat source was energised. The evaporation of solvent from a sample draws heat energy from its container which in turn cools the sample holder supporting the container. The temperature sensor 40 is used to monitor the temperature of the sample holders and generate a corresponding signal which is fed to the thermostatic control arrangement 42. In response to detection of a fall in the temperature of the sample holders below the target temperature, the thermostatic control arrangement turns on the heat source until the desired temperature for the sample holders is restored.

As an evaporation process approaches its endpoint, the amount of solvent remaining reduces and so the rate of evaporation reduces. Consequently, the amount of heat energy required to maintain the temperature of the sample holders is similarly reduced and this is reflected in shorter “on” periods for the heat source, with generally increasing lengths of “off” intervals between them. Accordingly, the progress of the evaporation procedure can be monitored with reference to the amount of heat energy emitted by the heat source over an immediately preceding period (which may be in a range of around 5 to 15 minutes for example). The endpoint may be calculated as the time at which the heat flow parameter falls to a predetermined percentage of its maximum value. Its maximum value corresponds to continuous use of the heat source during the monitored preceding time period.

However, the inventors have determined that the accuracy of such an approach may be significantly reduced under some circumstances, for example when the amount of solvent to be evaporated from a sample is relatively low. This is because the heat energy required to bring the sample holders and containers up to the desired temperature (say 90 W for example) is then considerably greater than that required to evaporate the solvent (10 W for example) such that the sensitivity of the heat flow monitoring to the rate of evaporation is somewhat reduced. The present disclosure seeks to address this problem.

The controller of the evaporator 30 is configured to end an evaporation process when the heat flow parameter falls by a predetermined extent from its peak value measured during the current evaporation procedure, rather than with reference to a maximum achievable value. This may provide more reliable endpoint detection.

In preferred examples, the controller is configured to only start calculating values for the heat flow parameter once a threshold temperature has been reached. This serves to reduce the influence on the heat flow parameter of using a relatively large amount of heat energy to heat up the sample holders and containers.

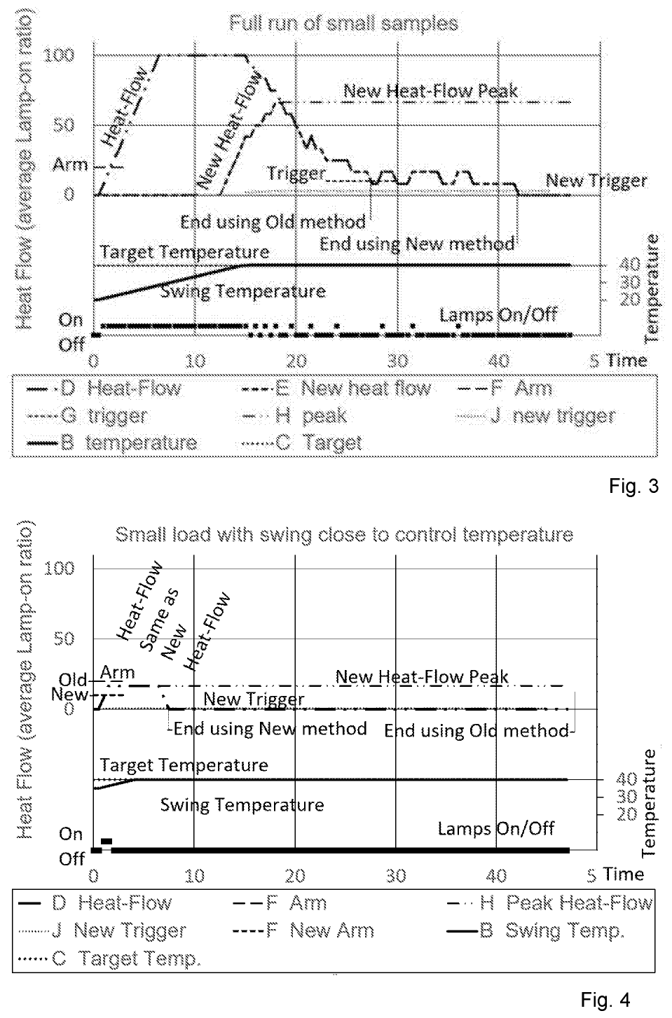

Examples of evaporation processes using techniques described herein will be discussed below with reference to FIGS. 2 to 4.

In FIGS. 2 to 4, time is plotted along the horizontal axis. A lower portion of each vertical axis shows plots of temperature along with a plot illustrating on/off periods of a heat source in the form of infrared lamps. An upper portion of each vertical axis shows plots of a heat flow parameter. The heat flow parameter indicates as a percentage the proportion of a set of time points (at 1 second intervals for example) during a preceding time period (5 minutes in these examples) for which the heat source was on.

The “swing temperature” denotes the temperature of the sample holders.

The plots marked “heat-flow” correspond to heat flow parameter data generated without use of a threshold temperature to mark the start of the flow parameter calculation. The plots marked “new heat-flow” correspond to heat flow parameter data generated using a threshold temperature to start the flow parameter calculation process.

A heat flow parameter threshold is marked “arm” in each of the Figures. This represents a minimum level of heat flow that needs to be measured before the controller begins monitoring for an endpoint of the evaporation process. As the endpoint corresponds to a calculated heat flow value, a threshold level of heat flow needs to be achieved at the beginning of the process which is above the expected endpoint value to ensure that the detected endpoint is valid.

A calculated endpoint level of heat flow for the plots marked “heat-flow” is denoted by the term “trigger” in the Figures, whilst a calculated endpoint level of heat flow for the plots marked “new heat-flow” is denoted “new trigger”.

In the evaporation process of FIG. 2, the heat flow value reaches its maximum as the swing is brought up to its target temperature. The trigger is calculated as a predetermined percentage of this maximum value which is considered to be a level of heat flow typically reached at completion of an evaporation process and may be around 20% of the maximum value, for example.

In FIG. 2, the new heat flow value calculations are only started once the swing temperature has reached a predetermined threshold (at around 3 to 5° C. below the target temperature for example). As a result, the plotted “new heat-flow” subsequently rises to a peak value, denoted “new heat-flow peak” in the Figure. This provides a more distinct indication or guide as to when the evaporation rate is likely to be at its highest. The “new trigger” is calculated with reference to this peak value, rather than the maximum heat flow value. The “new trigger” may be calculated as corresponding to 5% of the peak value for example. As the detected peak value provides a more reliable point of reference during the evaporation process, the new trigger may be set at a relatively low percentage of the peak value, giving a more accurate indication of the actual endpoint of the evaporation procedure.

In the example of FIG. 2, the trigger results in an endpoint (denoted “end using old method”) which is premature and before the sample is dry, and the “new trigger” marks an endpoint (denoted “end using new method”) which is somewhat later and more accurately corresponds to completion of the evaporation process, occurring soon after the sample has been dried.

A similar evaporation process to that of FIG. 2 is shown in FIG. 3. In this example, the samples are relatively small. As a result, the amount of heat energy required for evaporation is significantly smaller than that required to bring the sample holders up to the desired temperature. This leads to the plot of new heat-flow rising to a lower peak in comparison to FIG. 2. Thus, whilst the “trigger” value is the same in FIG. 3 as in FIG. 2, in FIG. 3, the “new trigger” is lower compared to that of FIG. 2 (since the “new heat-flow peak” value is lower in FIG. 3 than in FIG. 2). This in turn results in the new method causing the evaporation process to be allowed to run for longer to reach completion, and thereby producing a dry sample.

FIG. 4 relates to a scenario involving a relatively small sample, in which the temperature of the sample holders is relatively close to the target temperature at the start of the procedure. As a result, an “old arm” level typically used during the “old method” (around 20 to 25% of the maximum heat flow value for example) is not ever reached and so an endpoint is not determined with reference to “heat-flow”, and the procedure might only end when a default maximum evaporation duration defined by the controller 30 has elapsed. Due to the greater sensitivity of the “new method”, a “new arm” level may be utilised which is lower than a typical “old arm” level (with the new arm level at around 10% of the maximum heat flow value for example). Thus, even though the “new heat-flow” only reaches a relatively low value, this is sufficient to exceed the “new arm” level and thereby initiate the endpoint monitoring process. The peak value of the new-heat flow is then detected and used to set the “new trigger” level (which may be around 5% of the peak value for example). When the “new-heat flow” falls to the “new trigger level”, the evaporation process is ended at a point considerably earlier than would be the case using the “old method”. This significantly shortens the period of time for which the evaporation process is running, thereby enabling the next stage of processing of the sample to be commenced sooner. In addition, this also reduces the risk of damaging the sample due to overheating.

1. A method of conducting an evaporation procedure using an evaporator to evaporate a liquid component from a liquid sample in a container, the method comprising the steps of:
heating the container towards a target temperature using a heat source having a thermostatic control arrangement;
iteratively determining a value of a heat flow parameter with a controller, wherein the heat flow parameter is related to the amount of heat energy outputted by the heat source during an immediately preceding time period,
detecting a peak in the value of the heat flow parameter with the controller;
determining with the controller when the heat flow parameter value has fallen by a predetermined extent from its peak value; and
outputting a control signal from the controller in response to said determination, the control signal causing a further step in the evaporation procedure to be carried out.

2. The method of claim 1, including a step of monitoring a temperature indicative of that of the container;
wherein the preceding time period only starts when or after the monitored temperature has been raised by the heat source to a threshold temperature.

3. The method of claim 2, wherein the threshold temperature is equal to or a predetermined extent below the target temperature.

4. The method of claim 1, wherein the heat flow parameter is dependent on the proportion of the preceding time period for which the heat source was on.

5. The method of claim 1, wherein the heat flow parameter is dependent on the proportion of a set of time points during the preceding time period when the heat source was on.

6. The method of claim 1, wherein the controller determines when the heat flow parameter value has fallen to a predetermined percentage of its peak value.

7. An evaporator arranged to carry out an evaporation procedure to evaporate a liquid component from a liquid sample in a container according to the method of claim 1, the evaporator comprising:
a heat source for heating the container and having a thermostatic control arrangement; and
a controller which is communicatively coupled to the heat source and is configured to determine the heat flow parameter, detect a peak in the value of the heat flow parameter, determine when the heat flow parameter value has fallen by a predetermined extent from its peak value, and output a control signal in response to said determination, the control signal causing a further step in the evaporation procedure to be carried out.
